(19) United States
(12) Patent Application Publication
(10) Pub. No.: US 2026/0346379 A1
(43) Pub. Date: Nov. 5, 2026

(54) LASER-INDUCED WIRE MELTING DEVICE AND METHOD FOR ULTRAFAST LASER SURFACE PRETREATMENT OF MAGNESIUM-LITHIUM WELDING WIRE

(71) Applicant: NANJING UNIVERSITY OF AERONAUTICS AND ASTRONAUTICS, Nanjing (CN)

(72) Inventors: Xiaohong ZHAN, Nanjing (CN); Yanqiu ZHAO, Nanjing (CN); Haifu ZHANG, Nanjing (CN); Xiaojie CUI, Nanjing (CN)

(21) Appl. No.: 19/712,224

(22) Filed: Jun. 18, 2026

(30) Foreign Application Priority Data
Dec. 30, 2025 (CN) 202512015012.2

(51) Int. Cl. B23K 26/60; B23K 26/12; B23K 26/16; B23K 26/342; B23K 103/08

(52) U.S. Cl. CPC B23K 26/60; B23K 26/12; B23K 26/16; B23K 26/342; B23K 2103/15

(57) ABSTRACT

A laser-induced wire melting device, including a welding torch, a wire feeding mechanism, a fiber laser head, a fiber laser wire manufacturing system configured to output a fiber laser beam to melt the welding wire and stabilize a molten pool during an additive manufacturing process, a red-green laser layered cleaning system configured to output triangularly-distributed high-stability ultrashort pulsed laser beams for laser surface cleaning of the welding wire, a monitoring system configured for feedback of a surface quality state of the welding wire, a waste gas removal system configured to collect waste gas and debris, and a low-temperature gas supply system configured to maintain a low-temperature environment to prevent spontaneous combustion of magnesium alloy dust. A laser-induced wire melting method using such device is also provided.

### CROSS-REFERENCE TO RELATED APPLICATIONS

This application claims the benefit of priority from Chinese Patent Application No. 202512015012.2, filed on Dec. 30, 2025. The content of the aforementioned application, including any intervening amendments made thereto, is incorporated herein by reference in its entirety.

### TECHNICAL FIELD

This application relates to laser welding, and more particularly to a laser-induced wire melting device and method for ultrafast laser surface pretreatment of a magnesium-lithium welding wire.

### BACKGROUND

Magnesium-lithium alloy, as an ultra-light structural material, is characterized by low density, high specific strength, and excellent damping capacity, making it applicable to spacecraft skins, unmanned aerial vehicles, and portable electronic structural components. However, due to the high chemical activity, it is prone to oxidation (resulting in the formation of a dense oxide film) and contamination by oil and dust, resulting in poor wettability, weakened interlayer bonding strength and the occurrence of more pores and cracks during the laser wire additive manufacturing process.

The existing cleaning methods, such as chemical cleaning, sandblasting, and mechanical grinding, suffer from low efficiency, serious substrate damage and potential secondary contamination, and are not suitable for the on-line operation. Laser cleaning offers advantages of non-contact, locatable and automated operation. However, the nanosecond-scale laser cleaning involves significant thermal effects and potential re-oxidation problem. In addition, there are many types of oxides, varying in the removing difficulty, present on the surface of magnesium-lithium welding wires vary.

### SUMMARY

An object of the disclosure is to provide a laser-induced wire melting device and method for ultrafast laser surface pretreatment of a magnesium-lithium welding wire to overcome the defects in the prior art.

Technical solutions of the present disclosure are described as follows.

In a first aspect, this application provides a laser-induced wire melting device for ultrafast laser surface pretreatment of a magnesium-lithium welding wire, comprising:
a welding torch;
a wire feeding mechanism;
a fiber laser head;
a fiber laser wire manufacturing system;
a red-green laser layered cleaning system;
a waste gas removal system; and
a control system;
wherein the fiber laser wire manufacturing system comprises a fiber laser workpiece and a first transmission optical fiber; the fiber laser head is configured to process the fiber laser workpiece; the fiber laser workpiece is provided below the fiber laser head; and the first transmission optical fiber is connected to an input end of the fiber laser head;
the fiber laser workpiece is connected to a laser generating mechanism through the first transmission optical fiber;
the red-green laser layered cleaning system comprises a first red cleaning laser, a second red cleaning laser, a third red cleaning laser, a first green cleaning laser, a second green cleaning laser and a third green cleaning laser;
an output end of the first red cleaning laser is connected to the welding torch through a second transmission optical fiber; an output end of the second red cleaning laser is connected to the welding torch through a third transmission optical fiber; an output end of the third red cleaning laser is connected to the welding torch through a fourth transmission optical fiber; an output end of the first green cleaning laser is connected to the welding torch through a fifth transmission optical fiber; an output end of the second green cleaning laser is connected to the welding torch through a sixth transmission optical fiber; and an output end of the third green cleaning laser is connected to the welding torch through a seventh transmission optical fiber;
the waste gas removal system is provided at an input end of the welding torch, and comprises a first gas blowing mechanism, a second gas blowing mechanism, a third gas blowing mechanism, a fourth gas blowing mechanism, a first gas supply mechanism, a second gas supply mechanism, a first gas extraction mechanism and a second gas extraction mechanism;
the control system comprises an integrated control unit;
the integrated control unit is connected to the input end of the welding torch through a data transmission line; the integrated control unit is connected to an input end of the second red cleaning laser through a first output signal line; the integrated control unit is connected to an input end of the first red cleaning laser through a second output signal line; the integrated control unit is connected to an input end of the third red cleaning laser through a third output signal line; and the integrated control unit is connected to an input end of the laser generating mechanism through a fourth output signal line;
an output end of the integrated control unit is connected to a fifth output signal line;
an output end of the fifth output signal line is connected to the wire feeding mechanism; and
the wire feeding mechanism is connected to the welding torch through a wire feeding channel.

In some embodiments, a first galvanometer laser head, a second galvanometer laser head and a third galvanometer laser head are provided within the waste gas removal system;
the output end of the first red cleaning laser is connected to the first galvanometer laser head; the output end of the second red cleaning laser is connected to the second galvanometer laser head; and the output end of the third red cleaning laser is connected to the third galvanometer laser head; and
the first galvanometer laser head, the second galvanometer laser head, and the third galvanometer laser head are angularly spaced apart by 120 degrees, and are directed toward a focal point located at a center of the magnesium-lithium welding wire for cleaning.

In some embodiments, a first real-time monitoring camera, a second real-time monitoring camera and a third real-time monitoring camera are provided within the waste gas removal system; and
the first real-time monitoring camera, the second real-time monitoring camera and the third real-time monitoring camera are angularly spaced apart by 120 degrees, and are directed toward the focal point located at the center of the magnesium-lithium welding wire for real-time monitoring.

In some embodiments, the wire feeding mechanism comprises a clamping block, a wire spool, a rotating shaft and the wire feeding channel;
the wire spool is mounted on the rotating shaft;
the rotating shaft is provided on the clamping block; and
the wire feeding channel is configured to guide the magnesium-lithium welding wire from the wire spool to the welding torch.

In some embodiments, the laser-induced wire melting device further comprises a gas supply system;
the gas supply system comprises an argon gas cylinder, a compressed gas cylinder, a liquid nitrogen cylinder and a temperature sensor;
the temperature sensor is provided within the waste gas removal system, and is configured to detect an internal temperature of the waste gas removal system;
the argon gas cylinder is connected to the welding torch sequentially through a pressure relief valve, a mass flow controller and a first gas delivery pipeline;
an output end of the compressed gas cylinder communicates with the first gas blowing mechanism and the second gas blowing mechanism through a second gas delivery pipeline; and the output end of the compressed gas cylinder communicates with the third gas blowing mechanism and the fourth gas blowing mechanism through a third gas delivery pipeline; and
the liquid nitrogen cylinder communicates with an interior of the waste gas removal system through a fourth gas delivery pipeline to control the internal temperature of the waste gas removal system.

In some embodiments, two honeycomb pipelines are provided within the waste gas removal system at the input end of the welding torch;
the two honeycomb pipelines respectively communicate with the first gas extraction mechanism and the second gas extraction mechanism, such that negative pressure generated by the first gas extraction mechanism and the second gas extraction mechanism is distributed along two sides of the magnesium-lithium welding wire;
the two honeycomb pipelines consist of a first honeycomb pipeline and a second honeycomb pipeline located below the first honeycomb pipeline;
a tapered groove block is provided below the second honeycomb pipeline, and is fixed to an inner wall of the welding torch; and
the tapered groove block is configured to guide sinking debris into the second honeycomb pipeline for collection.

In some embodiments, an outer side of the first honeycomb pipeline is sleeved with a housing;
the housing is provided with an opening for the magnesium-lithium welding wire to pass through; and
a fifth gas delivery pipeline is provided within the housing, and is connected to the compressed gas cylinder for gas supply, such that an independent recirculation system is formed for secondary cleaning.

In a second aspect, this application provides a laser-induced wire melting method for ultrafast laser surface pretreatment of a magnesium-lithium welding wire, the laser-induced wire melting method being performed using the laser-induced wire melting device described above, and the laser-induced wire melting method comprising:
(S1) activating gas blowing, gas exchange and gas extraction to form a directional airflow; and checking a pressure differential for a dust collection and filtration;
(S2) introducing compressed gas from the compressed gas cylinder into the waste gas removal system through gas blowing mechanisms in cooperation with gas supply mechanisms, and extracting the compressed gas through gas extraction mechanisms; setting a target temperature of a chamber according to process specifications, and performing closed-loop operation of the gas supply system and the temperature sensor;
(S3) activating the control system, a monitoring system and the fiber laser wire manufacturing system and the red-green laser layered cleaning system; loading material and welding wire parameter files into a host computer; setting a recording threshold and an alarm threshold; performing self-checking on real-time monitoring cameras and an illumination system; and completing geometric calibration and time synchronization using a calibration plate;
(S4) performing optical path alignment and focusing, wherein a fiber laser and an ultrafast laser are subjected to collimation, beam splitting, reflection, galvanometer channel inspection under simulated output conditions, so as to complete focal length and spot position calibration;
(S5) calibrating geometric alignment of a wire feeding path extending from the wire feeding mechanism to the welding torch; setting a safe travel range and a soft limit; verifying light-touch positioning accuracy and zero-return accuracy of the welding torch under no-load conditions; operating the wire feeding mechanism under the no-load conditions to observe engagement of a wire guiding mechanism, a pressing mechanism, a wire feeding roller, as well as consistency of the wire feeding mechanism and an encoder of the control system;
(S6) performing linkage testing among the monitoring system, the red-green laser layered cleaning system and the fiber laser wire manufacturing system under the no-load conditions to verify consistency among a wire feeding trajectory, a galvanometer scanning trajectory, and image acquisition timing;
performing testing on a test sample to confirm that circumferential oxidation differences are correctly distinguished by the monitoring system and differentiated cleaning is performed via the first galvanometer laser head, the second galvanometer laser head and the third galvanometer laser head, wherein dust is entrained by the directional airflow and discharged; and
(S7) performing additive manufacturing through steps of:
establishing stable shielding gas conditions and target temperature and humidity conditions;
initiating laser deposition under low power conditions with short scanning passes;
continuously monitoring synchronization among laser power, duty cycle, scanning trajectory and wire feeding speed; and
triggering interlocking shutdown upon detection of abnormal conditions.

Compared to the prior art, the present disclosure has the following beneficial effects.

Through real-time monitoring of oxidation conditions in different regions of the surface of the magnesium-lithium welding wire during the cleaning process by the monitoring system, and under unified coordinated control of the control system, the red-green laser layered cleaning system respectively generates green laser beams and red laser beams to remove oxides on the surface of the welding wire. After completion of the cleaning process, a laser wire melting additive manufacturing process is performed, thereby solving problems of oxide formation on the surface of the magnesium-lithium welding wire caused by prolonged storage and poor weldability resulting therefrom.

### BRIEF DESCRIPTION OF THE DRAWINGS

FIG. 1 is an overall structural view of a laser-induced wire melting device for ultrafast laser surface pretreatment of a magnesium-lithium welding wire of Embodiment 1 of the present disclosure;

FIG. 2 is a positional distribution view of a first gas blowing mechanism and a second gas blowing mechanism of Embodiment 1 of the present disclosure;

FIG. 3 is a positional distribution view of real-time monitoring cameras for a cleaning process of Embodiment 1 of the present disclosure;

FIG. 4 is a positional distribution view of galvanometer laser heads in a waste gas removal system according to Embodiment 1 of the present disclosure;

FIG. 5 is a positional distribution view of a third gas blowing mechanism and a fourth gas blowing mechanism of Embodiment 1 of the present disclosure;

FIG. 6 is an enlarged view of an optical path of the galvanometer laser heads of Embodiment 1 of the present disclosure;

FIG. 7 is a detailed structural view of a cleaning mechanism of Embodiment 1 of the present disclosure; and

FIG. 8 is a schematic structural view of Embodiment 2 of the present disclosure.

In the figures: 1—fiber laser wire manufacturing system; 11—fiber laser workpiece; 12—first transmission optical fiber; 2—red-green laser layered cleaning system; 21—first red cleaning laser; 22—second red cleaning laser; 23—third red cleaning laser; 24—first green cleaning laser; 25—second green cleaning laser; 26—third green cleaning laser; 211—second transmission optical fiber; 221—third transmission optical fiber; 231—fourth transmission optical fiber; 241—fifth transmission optical fiber; 251-sixth transmission optical fiber; 261—seventh transmission optical fiber; 3—fiber laser head; 4—galvanometer laser head assembly; 41—first galvanometer laser head; 42—second galvanometer laser head; 43—third galvanometer laser head; 5—gas blowing system; 51—first gas blowing mechanism; 52—second gas blowing mechanism; 53—third gas blowing; 54—fourth gas blowing mechanism; 55—first gas supply mechanism; 56—second gas supply mechanism; 57—first gas extraction mechanism; 58—second gas extraction mechanism; 6—real-time monitoring system; 61—first real-time monitoring camera; 62—second real-time monitoring camera; 63—third real-time monitoring camera; 7—control system; 71—integrated control unit; 711—data transmission line; 712—first output signal line; 713—second output signal line; 714—third output signal line; 715—fifth output signal line; 716—fourth output signal line; 8—gas supply system; 81—argon gas cylinder; 82—compressed gas cylinder; 83—liquid nitrogen cylinder; 811—first gas delivery pipeline; 821—second gas delivery pipeline; 822—third gas delivery pipeline; 831—fourth gas delivery pipeline; 832—temperature sensor; 9—wire feeding mechanism; 91—clamping block; 92—wire spool; 93—rotating shaft; 94—wire feeding channel; 10—welding torch; 13—honeycomb pipeline; 14—fifth gas delivery pipeline; 15—housing; 16—laser generating mechanism; and 17—tapered groove block.

### DETAILED DESCRIPTION OF EMBODIMENTS

The technical solutions in the embodiments of the present disclosure will be described clearly and completely below in conjunction with the accompanying drawings. It is obvious that the described embodiments are merely some embodiments of the present disclosure, instead of all embodiments. Based on the embodiments in the present disclosure, all other embodiments obtained by those of ordinary skill in the art without making creative effort shall fall within the scope of the present disclosure defined by the appended claims.

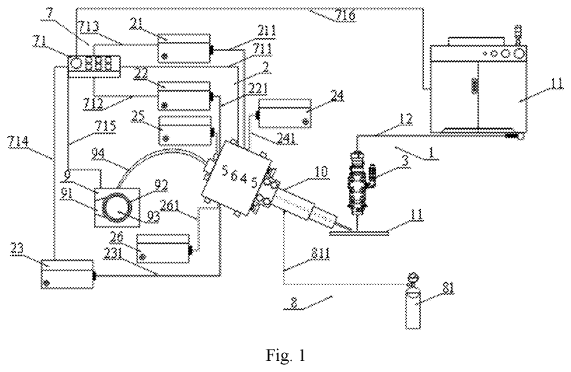

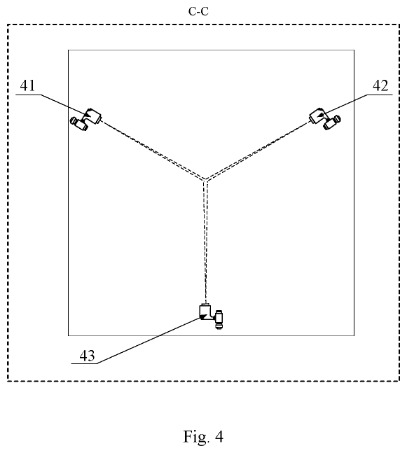

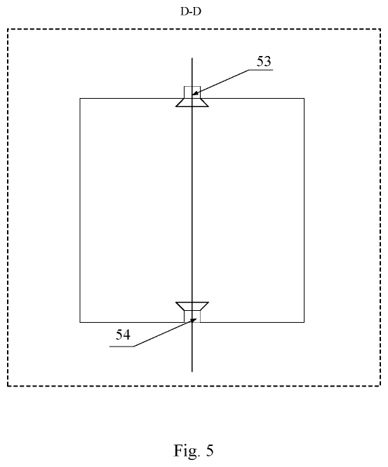

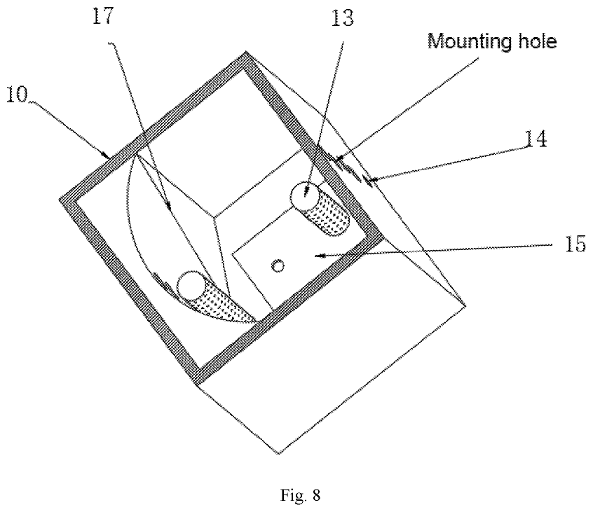

As shown in FIGS. 1-8, an embodiment of the present disclosure provides a laser-induced wire melting device for ultrafast laser surface pretreatment of a magnesium-lithium welding wire, including a welding torch 10, a wire feeding mechanism, a fiber laser head 3, a fiber laser wire manufacturing system, a red-green laser layered cleaning system, a waste gas removal system and a control system.

The fiber laser wire manufacturing system includes a fiber laser workpiece 11 and a first transmission optical fiber 12. The fiber laser head 3 is configured to process the fiber laser workpiece 11. The fiber laser workpiece 11 is provided below the fiber laser head 3. The first transmission optical fiber 12 is connected to an input end of the fiber laser head 3. The fiber laser workpiece 11 is connected to a laser generating mechanism 16 through the first transmission optical fiber 12.

The red-green laser layered cleaning system includes a first red cleaning laser 21, a second red cleaning laser 22, a third red cleaning laser 23, a first green cleaning laser 24, a second green cleaning laser 25 and a third green cleaning laser 26. An output end of the first red cleaning laser 21 is connected to the welding torch 10 through a second transmission optical fiber 211. An output end of the second red cleaning laser 22 is connected to the welding torch 10 through a third transmission optical fiber 221. An output end of the third red cleaning laser 23 is connected to the welding torch 10 through a fourth transmission optical fiber 231. An output end of the first green cleaning laser 24 is connected to the welding torch 10 through a fifth transmission optical fiber 241. An output end of the second green cleaning laser 25 is connected to the welding torch 10 through a sixth transmission optical fiber 251. An output end of the third green cleaning laser 26 is connected to the welding torch 10 through a seventh transmission optical fiber 261.

The waste gas removal system is provided at an input end of the welding torch 10, and includes a first gas blowing mechanism 51, a second gas blowing mechanism 52, a third gas blowing mechanism 53, a fourth gas blowing mechanism 54, a first gas supply mechanism 55, a second gas supply mechanism 56, a first gas extraction mechanism 57 and a second gas extraction mechanism 58.

The control system includes an integrated control unit 71. The integrated control unit 71 is connected to the input end of the welding torch 10 through a data transmission line 711. The integrated control unit 71 is connected to an input end of the second red cleaning laser 22 through a first output signal line 712. The integrated control unit 71 is connected to an input end of the first red cleaning laser 21 through a second output signal line 713. The integrated control unit 71 is connected to an input end of the third red cleaning laser 23 through a third output signal line 714. The integrated control unit 71 is connected to an input end of the laser generating mechanism 16 through a fourth output signal line 716. An output end of the integrated control unit 71 is connected to a fifth output signal line 715. An output end of the fourth output signal line 715 is connected to the wire feeding mechanism. The wire feeding mechanism is connected to the welding torch 10 through a wire feeding channel 94.

In some embodiments, a first galvanometer laser head 41, a second galvanometer laser head 42 and a third galvanometer laser head 43 are provided within the waste gas removal system. The output end of the first red cleaning laser 21 is connected to the first galvanometer laser head 41. The output end of the second red cleaning laser 22 is connected to the second galvanometer laser head 42. The output end of the third red cleaning laser 23 is connected to the third galvanometer laser head 43. The first galvanometer laser head 41, the second galvanometer laser head 42, and the third galvanometer laser head 43 are angularly spaced apart by 120 degrees, and are directed toward a focal point located at a center of the magnesium-lithium welding wire for cleaning.

In some embodiments, a first real-time monitoring camera 61, a second real-time monitoring camera 62, and a third real-time monitoring camera 63 are provided within the waste gas removal system. The first real-time monitoring camera 61, the second real-time monitoring camera 62 and the third real-time monitoring camera 63 are angularly spaced apart by 120 degrees, and are directed toward the focal point located at the center of the magnesium-lithium welding wire for real-time monitoring. In some embodiments, the wire feeding mechanism includes a clamping block 91, a wire spool 92, a rotating shaft 93 and the wire feeding channel 94. The wire spool 92 is mounted on the rotating shaft 93. The rotating shaft 93 is arranged on the clamping block 91. The wire feeding channel 94 is configured to guide the magnesium-lithium welding wire from the wire spool 92 to the welding torch 10.

In some embodiments, the laser-induced wire melting device further includes a gas supply system. The gas supply system includes an argon gas cylinder 81, a compressed gas cylinder 82, a liquid nitrogen gas cylinder 83, and a temperature sensor 832. The temperature sensor 832 is provided within the waste gas removal system, and is configured to detect an internal temperature of the waste gas removal system. The argon gas cylinder 81 is connected to the welding torch 10 sequentially through a pressure relief valve, a mass flow controller and a first gas delivery pipeline 811. An output end of the compressed gas cylinder 82 communicates with the first gas blowing mechanism 51 and the second gas blowing mechanism 52 through a second gas delivery pipeline 821. The output end of the compressed gas cylinder 82 communicates with the third gas blowing mechanism 53 and the fourth gas blowing mechanism 54 through a third gas delivery pipeline 822. The liquid nitrogen gas cylinder 83 communicates with an interior of the waste gas removal system through a fourth gas delivery pipeline 831 to control the internal temperature of the waste gas removal system.

In some embodiments, two honeycomb pipelines 13 are provided within the waste gas removal system at the input end of the welding torch 10. The two honeycomb pipelines 13 respectively communicate with the first gas extraction mechanism 57 and the second gas extraction mechanism 58, such that negative pressure generated by the first gas extraction mechanism 57 and the second gas extraction mechanism 58 is distributed along two sides of the magnesium-lithium welding wire. The two honeycomb pipelines 13 consist of a first honeycomb pipeline 13 and a second honeycomb pipeline 13 located below the first honeycomb pipeline 13. A tapered groove block 17 is provided below the second honeycomb pipeline 13, and is fixed to an inner wall of the welding torch 10. The tapered groove block 17 is configured to guide sinking debris into the second honeycomb pipeline 13 for collection.

In some embodiments, an outer side of the first honeycomb pipeline 13 is sleeved with a housing 15. The housing 15 is provided with an opening for the magnesium-lithium welding wire to pass through. A fifth gas delivery pipeline 14 is provided within the housing 15, and is connected to the compressed gas cylinder 82 for gas supply, such that an independent recirculation system is formed for secondary cleaning.

### Embodiment 1

As shown in FIG. 1, the present disclosure provides a laser-induced wire melting device for ultrafast laser surface pretreatment of a magnesium-lithium welding wire. The laser-induced wire melting device includes a fiber laser wire manufacturing system. The fiber laser wire manufacturing system is configured to generate a fiber laser beam. A portion of the energy of the fiber laser beam is applied to the welding wire to melt the welding wire, while another portion of the fiber laser beam is applied to the workpiece to achieve deep-penetration metal welding.

The laser-induced wire melting device further includes a red-green laser layered cleaning system 2, a fiber laser head 3, a galvanometer laser head assembly 4, a gas blowing system 5, a real-time monitoring system 6 for the cleaning process, a control system 7, a gas supply system 8, a wire feeding mechanism 9 and a welding torch 10. The galvanometer laser head assembly 4 is provided within a waste gas removal system. The spatial arrangement of the main body structure of the waste gas removal system is configured to avoid interference with a beam transmission path. The control system 7 is electrically connected to the fiber laser wire manufacturing system 1, the red-green laser layered cleaning system 2 and the real-time monitoring system 6 through signal lines. The electrical connections are implemented using conventional connection structures. The control system 7 is configured to control the fiber laser wire manufacturing system 1, the red-green laser layered cleaning system 2, and the real-time monitoring system 6.

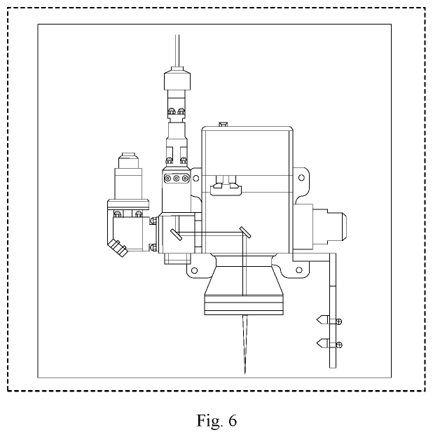

The red-green laser layered cleaning system is configured to perform real-time cleaning of the welding wire. Laser beams generated by the red-green laser layered cleaning system are applied to a surface of the welding wire within the laser-induced wire melting device to remove oxides formed on the surface of the welding wire. The red-green laser layered cleaning system includes a first red cleaning laser 21, a second red cleaning laser 22, a third red cleaning laser 23. The galvanometer laser head assembly 4 includes a first galvanometer laser head 41, a second galvanometer laser head 42 and a third galvanometer laser head 43. The first galvanometer laser head 41, the second galvanometer laser head 42 and the third galvanometer laser head 43 are angularly spaced apart by 120 degrees, and are directed toward a focal point located at a center of the magnesium-lithium welding wire. As shown in FIG. 6, a structure of the galvanometer laser heads and an optical path configuration are illustrated. The laser cleaning process enables layered and region-specific cleaning of the welding wire. An outer layer of the welding wire mainly includes porous and loosely bound reaction products such as LiOH and Li₂CO₃ formed via reactions with moisture and CO₂, optionally mixed with salts and oil contaminants. Green laser irradiation is configured to remove, carbonize, or ablate the outer loose layer and contaminants. Multiphoton absorption and defect activation are utilized to induce low-energy micro-ablation to pre-crack the surface layer for subsequent removal. A middle layer of the welding wire mainly includes a mixed layer of Li₂O and MgO with moderate density, while an inner adhesion layer of the welding wire mainly includes dense MgO that is strongly bonded to the metal substrate and is relatively difficult to remove. A green-laser-first and red-laser-second irradiation sequence, or a combined green-red laser irradiation mode, is configured to induce laser-assisted delamination of the intermediate layer and the inner dense layer. After weakening the interface by green laser irradiation, a transient thermal stress gradient and localized nanoscale rapid ablation localized nanoscale rapid ablation are generated under red laser irradiation, thereby enabling complete removal of the oxide film. An energy ratio between the green laser and the red laser is adjusted within a range of 3:7 to 5:5. The green-first and red-second irradiation sequence is particularly effective for removing dense MgO layers.

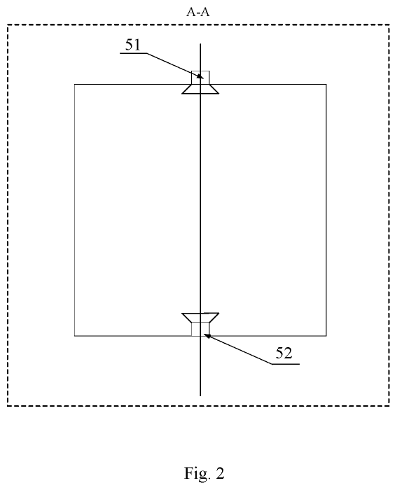

As shown in FIGS. 2, 5 and 7, the gas blowing system includes a first gas blowing mechanism 51 and a third gas blowing mechanism 53 provided at an upper portion of the waste gas removal system, a second gas blowing mechanism 52 and a fourth gas blowing mechanism 54 provided at a lower portion of the waste gas removal system, a first gas supply mechanism 55 and a second gas supply mechanism 56 provided at a left side of the waste gas removal system, and a first gas extraction mechanism 57 and a second gas extraction mechanism 58 provided at a right side of the waste gas removal system.

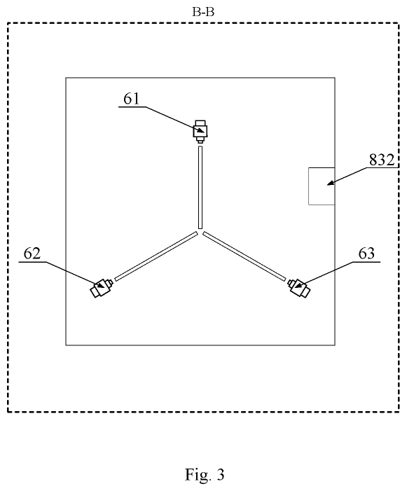

As shown in FIG. 3, the real-time monitoring system for the cleaning process includes a first real-time monitoring camera 61, a second real-time monitoring camera 62 and a third real-time monitoring camera 63 provided inside the waste gas removal system. The first real-time monitoring camera 61, the second real-time monitoring camera 62 and the third real-time monitoring camera 63 are angularly spaced apart by 120 degrees, and are directed toward the focal point located at the center of the magnesium-lithium welding wire.

The control system is configured to coordinately control and monitor the entire cleaning process. The control system includes an integrated control unit 71; a data transmission line 711 configured to acquire data from the real-time monitoring system of the cleaning process; and a first output signal line 712, a second output signal line 713, a third output signal line 714, a fourth output signal line 715, and a fifth output signal line 716 configured to transmit control instructions. The control system is configured to perform data acquisition and control command transmission, and is configured to function as a central control unit of the laser-induced wire melting device.

The welding wire feeding mechanism is configured to feed the welding wire under commands from the control system. The welding wire feeding mechanism includes a clamping block 91, a wire spool 92, a rotating shaft 93 and a wire feeding channel. The wire spool 92 is mounted on a rotating shaft 93. The rotating shaft 93 is mounted on the clamping block 91. The magnesium-lithium welding wire is guided through the wire feeding channel 94, is automatically fed into the red-green laser layered cleaning system, and is subsequently delivered to the welding torch 10.

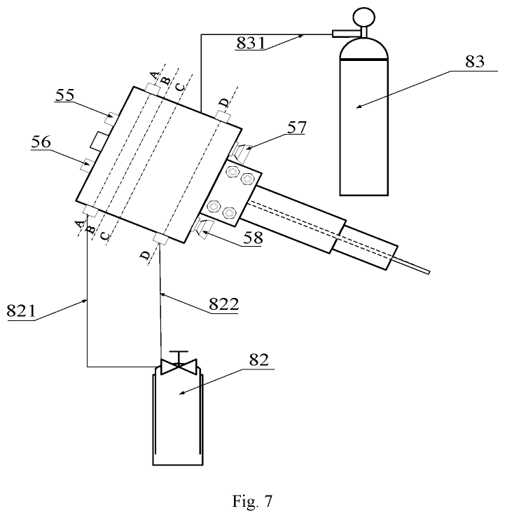

As shown in FIG. 7, the gas supply system includes a liquid nitrogen cylinder 83. A temperature sensor 832 is provided within the waste gas removal system. A target temperature value is set, and the temperature sensor 832 cooperates with a solenoid valve to control the liquid nitrogen cylinder 83 to precisely regulate a nitrogen gas flow, thereby maintaining a constant and controllable internal temperature of the waste gas removal system.

The present disclosure also provides a laser-induced wire melting method for ultrafast laser surface pretreatment of a magnesium-lithium welding wire, the laser-induced wire melting method performed based on the above-described laser-induced wire melting device, and the laser-induced wire melting method includes the following steps.

Step (1) Gas blowing, gas exchange and gas extraction are activated to form a directional airflow, and a pressure differential is checked for a dust collection and filtration.

Step (2) Leakage inspection of a gas circuit and the gas supply system is performed. Compressed gas is introduced from the compressed gas cylinder into the waste gas removal system through gas supply mechanisms and gas blowing mechanisms, and the compressed gas is extracted through gas extraction mechanisms. A target temperature of a chamber is set according to process specifications. Closed-loop operation of the gas supply system and the temperature sensor 832 is performed.

Step (3) The control system, the real-time monitoring system, and the fiber laser wire manufacturing system and the red-green laser layered cleaning system are activated. Material and welding wire parameter files are loaded into a host computer, and a recording threshold and an alarm threshold are set. Self-checking is performed on the real-time monitoring cameras and an illumination system, and geometric calibration and time synchronization are completed using a calibration plate.

Step (4) Optical path alignment and focusing are performed. A fiber laser and an ultrafast laser are subjected to collimation, beam splitting, reflection, and galvanometer channel inspection under simulated output conditions, so as to complete focal length and spot position calibration using a target provided by a manufacturer.

Step (5) Calibration of geometric alignment of a wire feeding path extending from the wire feeding mechanism to the welding torch is performed. A safe travel range and a soft limit are set. Light-touch positioning accuracy and zero-return accuracy of the welding torch are verified under no-load conditions. The wire feeding mechanism is operated under the no-load conditions to observe engagement of a wire guiding mechanism, a pressing mechanism and a wire feeding roller, as well as consistency of the wire feeding mechanism and an encoder of the control system.

Step (6) Linkage testing of the monitoring system, the red-green laser layered cleaning system and the fiber laser wire manufacturing system is performed under the no-load conditions to verify consistency among a wire feeding trajectory, a galvanometer scanning trajectory, and image acquisition timing. Low-power and short-duration testing is performed on a test sample to confirm that circumferential oxidation differences are correctly distinguished by the monitoring system and differentiated cleaning is performed through via the first galvanometer laser head, the second galvanometer laser head and the third galvanometer laser head. Dust is entrained by the directional airflow and discharged.

Step (7) Additive manufacturing is performed through the following steps. Stable shielding gas conditions and target temperature and humidity conditions are established. Laser deposition is initiated under low-power conditions with short scanning passes. Synchronization among laser power, duty cycle, scanning trajectory, and wire feeding speed is continuously monitored, and interlocking shutdown is triggered upon detection of abnormal conditions.

Therefore, the present disclosure provides the above-described laser-induced wire melting device and method for ultrafast laser surface pretreatment of the magnesium-lithium welding wire. Through synchronized control of the real-time monitoring system for the cleaning process, the red-green laser layered cleaning system and the control system, and by outputting unbalanced energy from the red-green laser layered cleaning system, non-equilibrium cleaning and layered removal of the magnesium-lithium welding wire are achieved, thereby solving the problems of easy oxidation and poor weldability of the magnesium-lithium welding wire.

### Embodiment 2

On the basis of Embodiment 1, a housing 15, honeycomb pipelines 13, and a fifth gas delivery pipeline 14 are provided, such that a primary fine-cleaning stage is introduced during a cleaning process involving gas blowing and gas extraction of the welding wire. This prevents irregular movement of debris caused by blowing and suction occurring within the same space, which may otherwise lead to disordered dust distribution and result in some debris being carried into a subsequent welding process, thereby affecting welding quality. By implementing a two-stage cleaning system, an independent recirculation system is realized, which prevents external contaminants from entering the cleaning system while further enabling fine cleaning of the welding wire, thereby achieving a high-precision cleaning effect.

Described above are merely preferred embodiments of the present disclosure, and are not intended to limit the scope of the present disclosure. It should be understood that various modifications, changes and replacements made by those skilled in the art without departing from the spirit of the disclosure shall fall within the scope of the present disclosure defined by the appended claims.

What is claimed is:

1. A laser-induced wire melting device for ultrafast laser surface pretreatment of a magnesium-lithium welding wire, comprising:
a welding torch;
a wire feeding mechanism;
a fiber laser head;
a fiber laser wire manufacturing system;
a red-green laser layered cleaning system;
a waste gas removal system;
a control system; and
a gas supply system;
wherein the fiber laser wire manufacturing system comprises a fiber laser workpiece and a first transmission optical fiber; the fiber laser head is configured to process the fiber laser workpiece; the fiber laser workpiece is provided below the fiber laser head; and the first transmission optical fiber is connected to an input end of the fiber laser head;
the fiber laser workpiece is connected to a laser generating mechanism through the first transmission optical fiber;
the red-green laser layered cleaning system comprises a first red cleaning laser, a second red cleaning laser, a third red cleaning laser, a first green cleaning laser, a second green cleaning laser and a third green cleaning laser;
an output end of the first red cleaning laser is connected to the welding torch through a second transmission optical fiber; an output end of the second red cleaning laser is connected to the welding torch through a third transmission optical fiber; an output end of the third red cleaning laser is connected to the welding torch through a fourth transmission optical fiber; an output end of the first green cleaning laser is connected to the welding torch through a fifth transmission optical fiber; an output end of the second green cleaning laser is connected to the welding torch through a sixth transmission optical fiber; and an output end of the third green cleaning laser is connected to the welding torch through a seventh transmission optical fiber;
the waste gas removal system is provided at an input end of the welding torch, and comprises a first gas blowing mechanism, a second gas blowing mechanism, a third gas blowing mechanism, a fourth gas blowing mechanism, a first gas supply mechanism, a second gas supply mechanism, a first gas extraction mechanism and a second gas extraction mechanism;
the control system comprises an integrated control unit;
the integrated control unit is connected to the input end of the welding torch through a data transmission line; the integrated control unit is connected to an input end of the second red cleaning laser through a first output signal line; the integrated control unit is connected to an input end of the first red cleaning laser through a second output signal line; the integrated control unit is connected to an input end of the third red cleaning laser through a third output signal line; and the integrated control unit is connected to an input end of the laser generating mechanism through a fourth output signal line;
an output end of the integrated control unit is connected to a fifth output signal line;
an output end of the fifth output signal line is connected to the wire feeding mechanism;
the wire feeding mechanism is connected to the welding torch through a wire feeding channel;
a first galvanometer laser head, a second galvanometer laser head and a third galvanometer laser head are provided within the waste gas removal system;
the output end of the first red cleaning laser is connected to the first galvanometer laser head; the output end of the second red cleaning laser is connected to the second galvanometer laser head; and the output end of the third red cleaning laser is connected to the third galvanometer laser head;
the first galvanometer laser head, the second galvanometer laser head, and the third galvanometer laser head are angularly spaced apart by 120 degrees, and are directed toward a focal point located at a center of the magnesium-lithium welding wire for cleaning;
the low-temperature gas supply system comprises an argon gas cylinder, a compressed gas cylinder, a liquid nitrogen cylinder and a temperature sensor;
the temperature sensor is provided within the waste gas removal system, and is configured to detect an internal temperature of the waste gas removal system;
the argon gas cylinder is connected to the welding torch sequentially through a pressure relief valve, a mass flow controller and a first gas delivery pipeline;
an output end of the compressed gas cylinder communicates with the first gas blowing mechanism and the second gas blowing mechanism through a second gas delivery pipeline; and the output end of the compressed gas cylinder communicates with the third gas blowing mechanism and the fourth gas blowing mechanism through a third gas delivery pipeline; and
the liquid nitrogen cylinder communicates with an interior of the waste gas removal system through a fourth gas delivery pipeline to control the internal temperature of the waste gas removal system.

2. The laser-induced wire melting device of claim 1, wherein a first real-time monitoring camera, a second real-time monitoring camera and a third real-time monitoring camera are provided within the waste gas removal system; and
the first real-time monitoring camera, the second real-time monitoring camera and the third real-time monitoring camera are angularly spaced apart by 120 degrees, and are directed toward the focal point located at the center of the magnesium-lithium welding wire for real-time monitoring.

3. The laser-induced wire melting device of claim 1, wherein the wire feeding mechanism comprises a clamping block, a wire spool, a rotating shaft and the wire feeding channel;
the wire spool is mounted on the rotating shaft;
the rotating shaft is provided on the clamping block; and
the wire feeding channel is configured to guide the magnesium-lithium welding wire from the wire spool to the welding torch.

4. The laser-induced wire melting device of claim 1, wherein two honeycomb pipelines are provided within the waste gas removal system at the input end of the welding torch;
the two honeycomb pipelines respectively communicate with the first gas extraction mechanism and the second gas extraction mechanism, such that negative pressure generated by the first gas extraction mechanism and the second gas extraction mechanism is distributed along two sides of the magnesium-lithium welding wire;
the two honeycomb pipelines consist of a first honeycomb pipeline and a second honeycomb pipeline located below the first honeycomb pipeline;
a tapered groove block is provided below the second honeycomb pipeline, and is fixed to an inner wall of the welding torch; and
the tapered groove block is configured to guide sinking debris into the second honeycomb pipeline for collection.

5. The laser-induced wire melting device of claim 4, wherein an outer side of the first honeycomb pipeline is sleeved with a housing;
the housing is provided with an opening for the magnesium-lithium welding wire to pass through; and
a fifth gas delivery pipeline is provided within the housing, and is connected to the compressed gas cylinder for gas supply, such that an independent recirculation system is formed for secondary cleaning.

6. A laser-induced wire melting method for ultrafast laser surface pretreatment of a magnesium-lithium welding wire, the laser-induced wire melting method being performed using the laser-induced wire melting device of claim 5, and the laser-induced wire melting method comprising:
(S1) activating gas blowing, gas exchange and gas extraction to form a directional airflow; and checking a pressure differential for dust collection and filtration;
(S2) introducing compressed gas from the compressed gas cylinder into the waste gas removal system through gas blowing mechanisms in cooperation with gas supply mechanisms, and extracting the compressed gas through gas extraction mechanisms; setting a target temperature of a chamber according to process specifications, and performing closed-loop operation of the gas supply system and the temperature sensor;
(S3) activating the control system, a monitoring system and the fiber laser wire manufacturing system and the red-green laser layered cleaning system; loading material and welding wire parameter files into a host computer; setting a recording threshold and an alarm threshold; performing self-checking on real-time monitoring cameras and an illumination system; and completing geometric calibration and time synchronization using a calibration plate;
(S4) performing optical path alignment and focusing, wherein a fiber laser and an ultrafast laser are subjected to collimation, beam splitting, reflection, galvanometer channel inspection under simulated output conditions, so as to complete focal length and spot position calibration;
(S5) calibrating geometric alignment of a wire feeding path extending from the wire feeding mechanism to the welding torch; setting a safe travel range and a soft limit; verifying light-touch positioning accuracy and zero-return accuracy of the welding torch under no-load conditions; operating the wire feeding mechanism under the no-load conditions to observe engagement of a wire guiding mechanism, a pressing mechanism, a wire feeding roller, as well as consistency of the wire feeding mechanism and an encoder of the control system;
(S6) performing linkage testing among the monitoring system, the red-green laser layered cleaning system and the fiber laser wire manufacturing system under the no-load conditions to verify consistency among a wire feeding trajectory, a galvanometer scanning trajectory, and image acquisition timing;
performing testing on a test sample to confirm that circumferential oxidation differences are correctly distinguished by the monitoring system and differentiated cleaning is performed via the first galvanometer laser head, the second galvanometer laser head and the third galvanometer laser head, wherein dust is entrained by the directional airflow and discharged; and
(S7) performing additive manufacturing through steps of:
establishing stable shielding gas conditions and target temperature and humidity conditions;
initiating laser deposition under low power conditions with short scanning passes;
continuously monitoring synchronization among laser power, duty cycle, scanning trajectory and wire feeding speed; and
triggering interlocking shutdown upon detection of abnormal conditions.
